(19) United States
(12) Patent Application Publication
(10) Pub. No.: US 2017/0255444 A1
(43) Pub. Date: Sep. 7, 2017

(54) WIRELESS AUDIO ENABLED HOUSEHOLD APPLIANCE

(71) Applicant: CE Brands, LLC, Miami, FL (US)

(72) Inventor: Jorge Garcia, Rogers, AR (US)

(73) Assignee: CE Brands, LLC, Miami, FL (US)

(21) Appl. No.: 15/450,952

(22) Filed: Mar. 6, 2017

Related U.S. Application Data
(60) Provisional application No. 62/303,801, filed on Mar. 4, 2016.

(51) Int. Cl. G06F 3/16; G05B 15/02; H04W 8/00; H04W 4/00; H04W 76/02

(52) U.S. Cl. CPC G06F 3/165; H04W 4/008; H04W 76/023; H04W 8/005; G05B 15/02

(57) ABSTRACT

The invention disclosed relates to systems for wirelessly communicating with a household appliance whereby a user is able to play audio through the household appliance. Embodiments of the related appliance apparatus include appliances, such as a coffee maker, that further include integral Bluetooth communication, digital audio processing and amplification, as well as an integrated speaker for output of the processed and amplified audio.

### CROSS-REFERENCE TO RELATED APPLICATIONS

This non-provisional utility patent application claims the benefit of U.S. Provisional Patent Application No. 62/303,801, filed on Mar. 4, 2016, currently pending, which is incorporated herein by reference.

### STATEMENT REGARDING FEDERALLY SPONSORED-RESEARCH OR DEVELOPMENT

None.

### FIELD OF THE INVENTION

The invention relates generally to the field of electro-mechanical apparatuses, and more particularly, to a household appliance apparatus enabled to receive a wireless digital audio signal and play said signal through included speaker or speakers.

### BACKGROUND

With the advent of portable computing devices, cloud computing, and “always-on” connectivity, users have become accustomed to the ease and convenience of listening to their favorite music, podcasts, or audio programs at any time through their mobile device. Streaming music has become a common-place convenience. Unfortunately, the audio quality produced by most mobile devices, such as tablets or smartphones, is not optimal.

All too often, casual music listeners and audiophiles alike, would like to enjoy their music where they spend a lot of time. For many, that is the kitchen and its surrounding areas. Unfortunately, for many, the only solution is to place their smartphones or tables on the kitchen counter for audio playback. This often results in a frustrated audio experience, in the best case, or a phone damaged by spilled liquid, in the worst case.

Attempts to solve this problem in the art are often clumsy, bulky, or expensive. In ceiling, or in-wall, audio systems are expensive to purchase and install and often require more hardware than is really needed or desired. Other solutions may be more economical, but require the addition of a wired or wireless speaker to an already cluttered kitchen counter where counter space and free electrical outlets are often at a premium.

It would, therefore, be desirable to have a multi-function home appliance apparatus that, in addition to performing its primary function, is further enabled to receive a wireless digital audio signal and play said signal through an included speaker or speakers.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provision; or is known to be relevant to an attempt to solve any problem with which this specification is concerned.

### SUMMARY

A preferred embodiment of the present invention is directed to an appliance further comprising a processing unit, a wireless communication unit, a signal amplifier, and an audio output means. By way of example, and not limitation, a preferred embodiment comprises a coffee maker appliance, further configured to receive digital audio data over Bluetooth wireless communications protocols, and output the data as an audio signal via a speaker or transducer, preferably located in the base of the unit. The addition of the Bluetooth speaker allows a user to listen to music through the coffee maker or other appliance, consolidating two devices into one. The preferred embodiment places the Bluetooth controls on the front of the unit for convenience. This embodiment further comprises drainage of coffee to the side of the coffee maker to prevent liquids from spilling over the Bluetooth controls.

Other embodiments contemplated to be within the scope of the invention may further comprise one or more USB charging ports. Additionally, while a coffee maker apparatus is disclosed for compactness of disclosure, it is within the scope of the present invention that other embodiments may be realized with other household appliances other than a coffee maker.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a diagrammatic view of a system comprising an embodiment of the present invention;

FIG. 2 is a simplified block diagram representation of the major components of an embodiment of the present invention; and

FIG. 3 is a composite view of multiple embodiments of the present invention.

### DESCRIPTION

In the Summary above, in the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Before describing in detail embodiments that are in accordance with the present invention, it should be observed that some of the embodiments may reside primarily in combinations of method steps and system components related to systems and methods for placing computation inside a communication network. Accordingly, the apparatus and system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the specification will conclude with claims defining the features of embodiments of the invention that are regarded as novel, it is believed that the invention will be better understood from a consideration of the following description in conjunction with the figures, in which like reference numerals are carried forward.

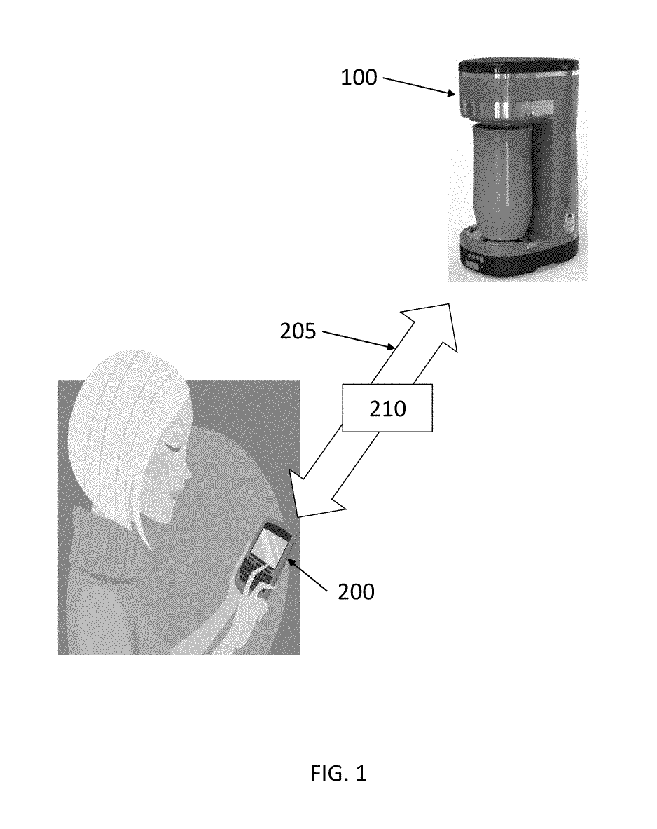

Referring to the figures in general, and to FIG. 1 in particular, we describe a system comprising an appliance apparatus 100 in digital wireless communication 205 with a mobile device 200 whereby the mobile device 200 discovers and pairs to the appliance apparatus 100, exchanges data packets 210 with the appliance apparatus 100, and the appliance apparatus 100 decodes the data packets 210 into an audio signal, amplifies the audio signal via an amplifier 220, and outputs the audio signal via a one or more speaker 250 integral to the appliance apparatus.

Appliance Apparatus 100

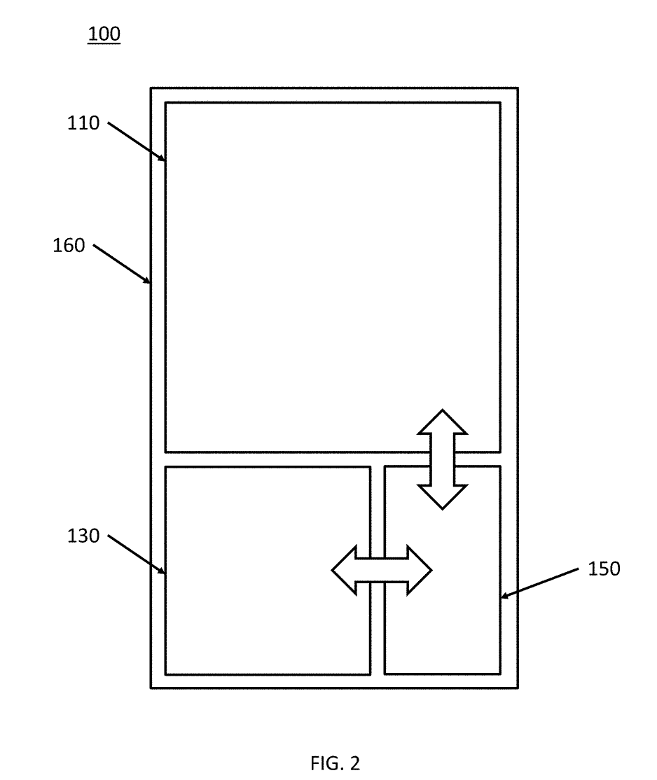

Referring to the figures in general, and to FIG. 2 in particular, we discuss now a preferred embodiment of the appliance apparatus 100. In this embodiment, by way of example and not limitation, an appliance apparatus 100 is comprised of: an appliance component 110, a wireless audio component 130, and an electronics control component 150. The components are related as follows: the appliance component 110, the wireless audio component 130, and the electronics control component 150 are all contained within a housing 160. The appliance component 110 and the wireless audio component 130 are separately electrically connected and functionally communicative with the electronics control component 150. The electronics control component 150 is configured to receive household current and deliver it via internal circuitry to the appliance component 110.

The Appliance Component 110

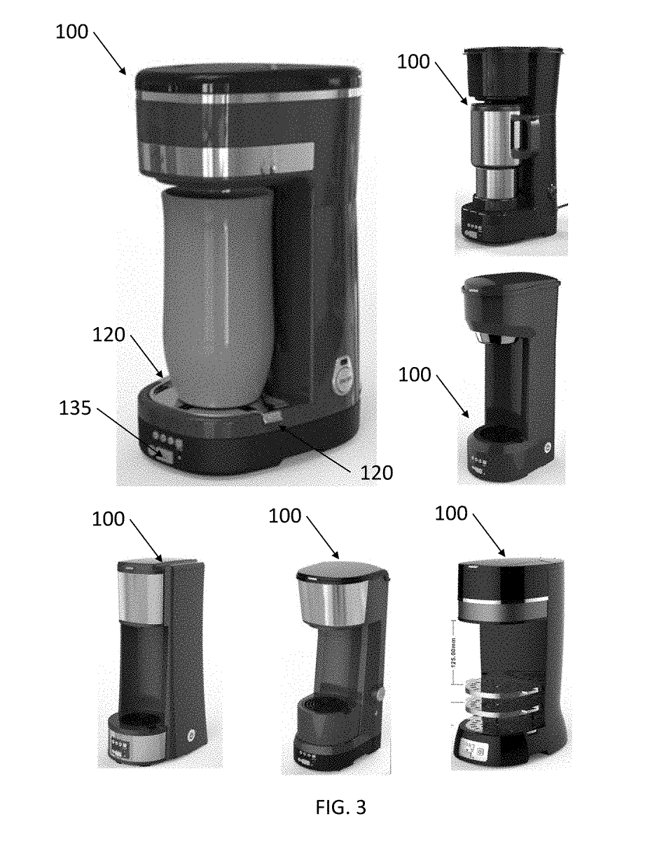

Embodiments of the invention contemplate an appliance component 110 that is chosen from those commonly known as a household electrical appliances. For example, the preferred embodiment of the present invention discloses an appliance component 110 that is a coffee maker. By way of example, and not limitation, coffee maker types include traditional carafe drip style, single serve, pod, and espresso type appliances. FIG. 3 illustrates embodiments of the invention in the form of various different types of coffee makers.

Embodiments of the invention wherein the appliance component is in the form of a coffee maker may additionally comprise a one or more overflow diversion means 120. This overflow diversion means 120 may be chosen from mechanical features such as channels, gutters, or drains, or a combination of channels, gutters, or drains. The overflow diversion means 120 is to be chosen and configured in such a way as to divert any overflow coffee, water, or other liquid away from the user interface area 135 of the wireless audio component 130. By way of example, in an embodiment where the coffee maker portion is located above the user interface area, which is located in the front-center of the apparatus, the liquid overflow may be directed to drain out of the back or sides of the coffee maker so as to not flow onto or over the controls of the user interface area.

Control circuitry for the appliance component 110, such as timers or temperature controllers, may be contemplated to be a sub-component of the electronics control module or as a separate module in serial communication between the electronics control module 150 and the appliance component 110.

The Wireless Audio Component 130

We discuss the wireless audio component 130. A preferred embodiment of the appliance apparatus 100 further comprises a wireless audio component 130 that is configured to receive digital data packets via wireless communication, process the digital data packets in to an audio signal, and output the audio signal as an audible sound wave.

The wireless audio component 130 is electrically and functionally connected to the electronics control component 150. Embodiments of the appliance apparatus 100 contemplate that the appliance component 110 and the wireless audio component 130 are independently powered and controlled by the electronics control component 150. In other embodiments, the appliance component and the wireless audio component are powered by the same power source.

In a preferred embodiment, the wireless audio component 130 is comprised of a wireless communication means, a processor means, an amplifier means, and an audio output means that are all electrically communicative with each other in order to receive digital data packets wirelessly, process the digital data packets into audio signals, amplify the audio signals, and output the audio signals. The wireless audio component 130 further comprises a user interface means that is functionally and electrically communicative with the other components of the wireless audio component 130 as well as the electronics control component 150.

The wireless communication means provides for the wireless interconnection of cellular phones, computers, and other electronic devices to the appliance apparatus 100. The wireless communications means may be chosen, based on the current state of the art, from known wireless communication means such as Bluetooth®, ZigBee®, or other wireless interconnection means as may be known in the art now or in the future.

The processor means and amplifier means may be chosen from standard devices, integrated circuits, or reference designs as may be known in the art to receive, decode, and amplify audio data.

The speaker means may be one or more speakers or transducers configured to receive electrical signals from the processor means and amplifier means and convert those electrical signals into audible sound waves.

A preferred embodiment of the invention is further comprised of a user interface means 135 comprising silicon covered tactile switches and indicator lights. The user interface means 135 may further comprise one or more of the following: power control, to turn the speaker on or off; volume control; play control (transport functions); wireless search; and phone functions, to answer or ignore calls.

While embodiments of the invention contemplate a wireless audio component 130 that is located anywhere within the apparatus housing, a preferred embodiment comprises a wireless audio component 130 that is located in the base of the housing, below the appliance component 110. In this configuration, the speaker means is ported downward so that the path of the sound waves can take advantage of the countertop surface for a fuller and richer sound experience.

The Electronics Control Module 150

Embodiments of the appliance apparatus 100 comprise an electronics control module 150. This electronics control module 150 is further comprised of a power cord for connecting to external power, a power regulator, and related power management circuitry.

Additional embodiments of the appliance apparatus 100 may further comprise a one or more USB charging port so that a user may plug in and charge a smartphone or tablet.

It is understood that the variations and options disclosed above with respect to the components of the apparatus embodiments, are also applicable as variations and options with respect to the components for the system embodiments.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A system for playing digital audio through an appliance apparatus, the system comprising:
an appliance apparatus configured to receive a data via a wireless network; and
a mobile device wirelessly communicative with the appliance apparatus;
whereby, the mobile device discovers and pairs to the appliance apparatus, and the appliance apparatus decodes the data into an audio signal, amplifies the audio signal via an amplifier, and outputs the audio signal via a one or more speaker integral to said appliance apparatus.

2. An appliance apparatus, the appliance apparatus comprising:
a housing;
an electronics control component integral to and operatively communicative with the housing;
an appliance component integral to and operatively communicative with the housing, and further electrically and functionally communicative with the electronics control component; and
a wireless audio component integral to and operatively communicative with the housing, and further electrically and functionally communicative with the electronics control component.
